(19) United States
(12) Patent Application Publication
(10) Pub. No.: US 2008/0022835 A1
(43) Pub. Date: Jan. 31, 2008

(54) Stringed instrument with message display

(76) Inventor: David Andrew Dunwoodie, Delta (CA)

Correspondence Address: NEXUS LAW GROUP LLP, 1500 - 701 WEST GEORGIA STREET, VANCOUVER, BC, V74-1C6, US

(21) Appl. No.: 11/493,499

(22) Filed: Jul. 25, 2006

(51) Int. Cl. G10D 3/04

(52) U.S. Cl. 84/298

(57) ABSTRACT

A message display system for a stringed instrument comprises a plurality of bridge pins, each bridge pin being formed with a top surface marked with indicia. The top surfaces with indicia are viewable when the a plurality of bridge pins are installed into a bridge of the instrument, and the bridge pins are arranged to display a message to a viewer. Trademarks, band names and short political or personal messages may be displayed. The indicia formed on the bridge pins are not limited to those of the Latin alphabet. The text and symbols of other writing systems or languages, for example, Japanese, Arabic, Chinese, or Korean, may be formed on the bridge pins. For beginner guitar players, the bridge pins may be used to mark the names of the strings (e.g. E A D G B E).

### BACKGROUND OF THE INVENTION

1. Field of Invention

The present invention relates generally to stringed musical instruments, and more particularly, to a stringed musical instrument such as a guitar having a system for displaying messages incorporated into the bridge pins of the instrument.

2. Background of the Invention and Description of Related Art

As best shown in FIG. 1, a conventional stringed instrument comprises a main guitar body 1 with a longitudinally extending neck member 7. The neck member extends from the body and has a distal end or guitar head 4 having a plurality of string receiving and tightening members 4a which retain a first end of each of the strings 3. A bridge 2 having a slot therein disposed perpendicularly to the neck member is connected to the guitar body 1 remote from the neck member. Strings 3 extend between bridge 2 and the string receiving and tightening members 4a such that the strings can be releasably placed under tension. The second end of each of the guitar strings 3 is fixed to the guitar bridge 2. As shown in more detail in FIG. 2, a saddle 5 comprising an elongated, narrow strip of hard material, such as ivory, bone or hard plastic, is slidably fitted into the slot in the bridge to support the strings. The second ends of the guitar strings 3 are inserted into respective pin holes on the bridge 2, and then fixed by respective bridge pins 6. When the strings are tightened, string tension presses the strings against the saddle and presses the saddle against the bottom of the slot in the bridge. When the instrument is played, vibrational energy from the strings is transmitted through the saddle and the bridge into the sounding board and into the body of the instrument, where the vibrational energy resonates and produces sound.

In conventional stringed musical instruments that employ bridge pins, the exposed top surfaces 8 of the pins are generally unmarked. Alternatively, the top surfaces may have a contrasting circular inlay usually made from plastic, abalone or mother of pearl for decorative purposes. The top surfaces are in plain view of anyone looking at the guitar, and the present invention is directed to a message display arrangement located on the exposed top surfaces of the pins.

### SUMMARY OF THE INVENTION

The present invention provides a message display system that can be used to conveniently and prominently display a message such as a trademark, word or logo on the surface of the pins.

Accordingly, the present invention provides a message display system for a stringed instrument comprising:
a plurality of bridge pins, each bridge pin being formed with a top surface marked with indicia, the top surface with indicia being viewable when the bridge pin is installed into a bridge of the instrument, and the bridge pins being arranged to display a message to a viewer.

The present invention also provides a kit for displaying a message on a stringed instrument comprising:

a plurality of bridge pins, each bridge pin being formed with a top surface marked with indicia;

wherein the bridge pins are installable into a bridge of the instrument by a user to display a desired message by the indicia on the exposed top surfaces of the pins.

In a further aspect, the present invention provides a method for displaying a message on a stringed instrument comprising:

providing bridge pins, each bridge pin being formed with a top surface marked with indicia; and

installing one or more bridge pins into a bridge of the instrument such that the top surfaces with indicia are viewable to display a message to a viewer.

The stringed instrument may be a guitar including an acoustic guitar. Other stringed instruments such as a banjo, classical guitar, bazooki or ukulele can also be fitted with message display system of the present invention. Any stringed instrument that relies on bridge pins to hold the strings is place can use the message display of the present invention.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Aspects of the present invention are illustrated, merely by way of example, in the accompanying drawings, in which:

FIG. 1 is a front view of a conventional guitar;

FIG. 2 is a side sectional view of a conventional bridge installed on a guitar;

FIG. 3 is a detail view of a bridge pin according to the present invention;

FIG. 4 is a detail view of a guitar bridge showing the message display system according to the present invention; and

FIG. 5 shows a kit form of the present invention comprising a collection of bridge pins retained in a resealable container.

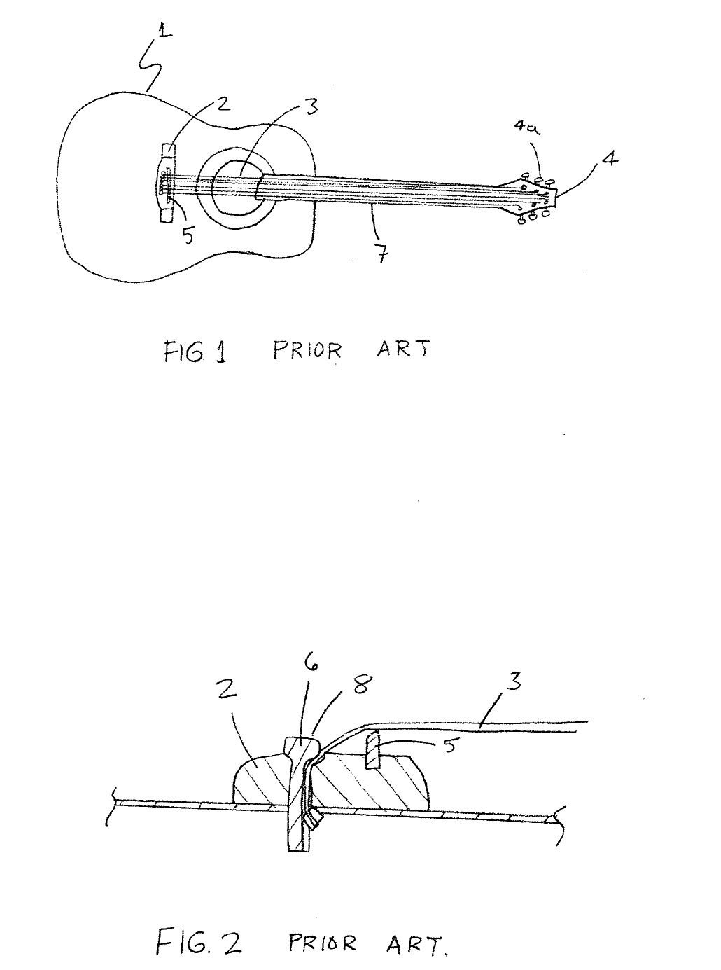

### DETAILED DESCRIPTION OF THE INVENTION

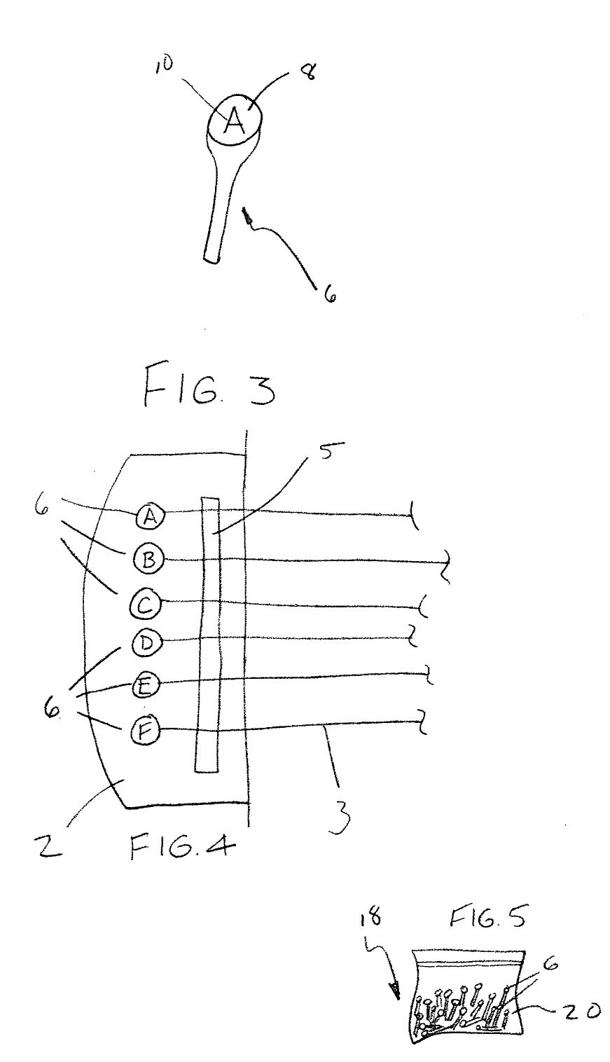

Referring to FIG. 3, there is shown a bridge pin 6 for use in the message display system of the present invention. The bridge pin includes a top surface 8 that is marked with indicia 10. Otherwise, bridge pin 6 is conventional in shape, appearance and function. In the illustrated embodiment, the indicia 10 comprises the letter “A” by way of example only. It will be appreciated that any letter of the alphabet, upper case or lower case, numerals, or other desired symbols, such as punctuation marks, can be formed on the top of each bridge pin. Other exemplary indicia that can be formed include the symbols:

˜ ` @ # $ % ̂ & * ( ) _ + = ′ ″ < > / | [ ] { }

or any other UNICODE character that can be generated on a computer keyboard. The indicia can be formed by printing, etching or any other suitable technique for forming a permanent mark on the top surface of the bridge pin.

To use the message display system, a plurality of bridge pins are selected to create a desired message 1. The selected bridge pins are then inserted into their conventional locations in the bridge 2 to secure the ends of strings 3 in place. The pins are also inserted in the appropriate order to display the desired message across the bridge of the guitar as best shown in FIG. 4. The top surfaces 8 with indicia 10 are exposed to be viewed by anyone looking at the instrument. FIG. 4 shows the bridge of an acoustic guitar, by way of example only. Due to the standard arrangement of the strings on an acoustic guitar the desired message must be read vertically. The message illustrated in FIG. 4 is simply the first six letters of the alphabet. Depending on the number of strings on the instrument, longer messages may be possible. The message display system of the present invention may be particularly useful for displaying the name of the manufacturer of the guitar such as GIBSON, FENDER or YAMAHA which are all conveniently six letters long. The bridge pins can also be used to display political messages (e.g. NO2WAR), band names (e.g. T-RAYS), messages to friends (e.g. ILUVU!) or other messages. The indicia formed on the bridge pins are not limited to those of the Latin alphabet. The text and symbols of other writing systems or languages, for example, Japanese, Arabic, Chinese, or Korean, may be formed on the bridge pins. For beginner guitar players, the bridge pins may be used to mark the names of the strings (e.g. E A D G B E).

The message display system of the present invention may be made available in a kit form so that owners can modify their guitars as desired. As illustrated in FIG. 5, each kit 18 would comprise a collection of bridge pins 6 according to the present invention, each pin being formed with a top surface marked with indicia, and the pins being stored in a convenient container such as a resealable bag 20. Preferably, the collection of pins would include at least one pin marked with each letter of the alphabet. Multiple copies of pins marked with more common letters such as vowels and commonly used consonants would be provided to allow a user to spell out a message that includes the same letter more than once.

While specific embodiments of the invention have been described and illustrated, such embodiments should be considered illustrative of the invention only and not as limiting the invention as construed in accordance with the accompanying claims.

What is claimed is:

1. A message display system for a stringed instrument comprising:
a plurality of bridge pins, each bridge pin being formed with a top surface marked with indicia, the top surface with indicia being viewable when the bridge pin is installed into a bridge of the instrument, and the bridge pins being arranged to display a message to a viewer.

2. A message display system as claimed in claim 1 in which the indicia comprise letters of the alphabet.

3. A message display system as claimed in claim 1 in which the indicia comprises numbers.

4. A message display system as claimed in claim 1 in which the indicia comprise UNICODE symbols.

5. A message display system as claimed in claim 1 in which the indicia comprise character sets for non-English languages.

6. A kit for displaying a message on a stringed instrument comprising:
a plurality of bridge pins, each bridge pin being formed with a top surface marked with indicia;
wherein the bridge pins are installable into a bridge of the instrument by a user to display a desired message by the indicia on the exposed top surfaces of the pins.

7. The kit as claimed in claim 6 in which the indicia are letters of the alphabet, and the kit includes at least one bridge pin marked with each letter of the alphabet.

8. The kit as claimed claim 6 including multiple bridge pins marked with the most common letters of the alphabet.

9. The kit as claimed in claim 6 including a resealable container to retain the pins when not installed in the bridge of the instrument.

10. A method for displaying a message on a stringed instrument comprising:
providing bridge pins, each bridge pin being formed with a top surface marked with indicia;
installing one or more bridge pins into a bridge of the instrument such that the top surfaces with indicia are viewable to display a message to a viewer

11. A method for displaying a message on a stringed instrument comprising:
providing bridge pins, each bridge pin being formed with a top surface marked with indicia;
selecting one or more bridge pins having indicia appropriate to create a desired message;
installing the one or more bridge pins into a bridge of the instrument such that the top surfaces with indicia are viewable to display the desired message.
